(19) United States
(12) Patent Application Publication
(10) Pub. No.: US 2013/0243034 A1
(43) Pub. Date: Sep. 19, 2013

(54) TEMPERATURE SENSING PORTION CAP AND ELECTRONIC THERMOMETER

(71) Applicants: Atsushi Kawano, Takarazuka-shi (JP); Katsuyoshi Morita, Kyoto-shi (JP)

(72) Inventors: Atsushi Kawano, Takarazuka-shi (JP); Katsuyoshi Morita, Kyoto-shi (JP)

(73) Assignee: OMRON HEALTHCARE CO., LTD., Muko-shi, Kyoto (JP)

(21) Appl. No.: 13/989,146

(22) PCT Filed: Oct. 27, 2011
(86) PCT No.: PCT/JP2011/074774

§ 371 Date: May 23, 2013

(30) Foreign Application Priority Data
Nov. 24, 2010 (JP) 2010-261227

(51) Int. Cl. G01K 7/02

(52) U.S. Cl. CPC G01K 7/02
USPC 374/170; 374/163

(57) ABSTRACT

A temperature sensing portion cap includes a tubular or substantially tubular body portion that is located toward an opening portion of a main body housing, and a bottomed accommodating portion that is in communication with the body portion and accommodates the temperature sensing portion. A temperature sensing portion supporting region is provided inside the accommodating portion, by an indented region that is indented toward the body portion being provided on a tip portion side of an outer surface of the accommodating portion.

### BACKGROUND OF THE INVENTION

1. Field of the Invention

The present invention relates to structures of a temperature sensing portion cap and an electronic thermometer.

2. Description of the Related Art

Generally, an electronic thermometer that measures body temperature by being placed in a measurement site, such as in the armpit or under the tongue, is provided with a hollow main body housing that has an opening portion at a tip, a temperature sensing portion that is drawn from inside the main body housing to outside the main body housing through the opening portion by a lead, and a temperature sensing portion cap that accommodates the temperature sensing portion and occludes the opening portion (e.g., JP 2007-120963A and JP 2009-300310A).

The temperature sensing portion is fixed to an accommodating portion inside the temperature sensing portion cap, with the performance of the electronic thermometer being greatly affected by variation in the fixing of the temperature sensing portion. The method of fixing the temperature sensing portion to the temperature sensing portion cap will now be described with reference to FIGS. 19 to 22.

FIG. 19 is an overall perspective view showing the structure of a temperature sensing portion cap 200, and FIG. 20 is a longitudinal sectional view of the temperature sensing portion cap 200. This temperature sensing portion cap 200 consists of a metal material such as stainless steel, and has a U-shaped cross-section. The temperature sensing portion cap 200 has a diameter (ΦD) of approximately 3-5 mm, and a length (L) of approximately 7-11 mm. Also, the size (volume) of a temperature sensing portion 73 discussed later is small at approximately 1 mm3, and the thickness of one lead 72 is thin at approximately 0.1 mm.

Methods of fixing the temperature sensing portion to the temperature sensing portion cap include: (a) packing the temperature sensing portion cap with adhesive and simultaneously fixing the temperature sensing portion to the temperature sensing portion cap and fixing the temperature sensing portion cap to the main body housing; and (b) fixing the temperature sensing portion to the temperature sensing portion cap by affixing a small amount of adhesive to a tip portion of the temperature sensing portion, and fixing the temperature sensing portion cap to the main body housing by applying more adhesive to the main body housing.

FIG. 21 is a cross-sectional view showing the case of (a). The temperature sensing portion cap 200 is packed with an adhesive 50, and the temperature sensing portion 73 to which the leads 72 are coupled is fixed to a bottom portion (tip portion) of the temperature sensing portion cap 200.

FIG. 22 is a cross-sectional view showing the case of (b). A small amount of adhesive is affixed to a tip portion of the temperature sensing portion 73 inside the temperature sensing portion cap 200, and the temperature sensing portion 73 to which the leads 72 are coupled is fixed to the bottom portion (tip portion) of the temperature sensing portion cap 200.

Here, with method (a), the temperature sensing portion cap 200 and the temperature sensing portion 73 are thermally bonded by the presence of the adhesive 50. However, heat diffuses throughout the layer of adhesive 50 inside the temperature sensing portion cap 200, slowing heat transfer to the temperature sensing portion 73.

Also, with method (b), a layer of air is provided inside the temperature sensing portion cap 200, thus allowing heat to be quickly transferred from the temperature sensing portion cap 200 to the temperature sensing portion 73 without diffusing. Also, the temperature sensing portion 73 need only be inserted until it butts against the bottom portion (tip portion) of the temperature sensing portion cap 200, making positioning of the temperature sensing portion 73 relative to the temperature sensing portion cap 200 comparatively easy. However, depending on how the adhesive 50 is affixed, the temperature sensing portion 73 may not be properly thermally bonded to the temperature sensing portion cap 200.

Thus, even though thermal bonding between the temperature sensing portion cap 200 and the temperature sensing portion 73 is strengthened when the packed amount of adhesive is large, thermal diffusion arises, slowing heat transfer to the temperature sensing portion 73. On the other hand, heat transfer to the temperature sensing portion 73 is faster when the packed amount of adhesive is small, but thermal bonding between the temperature sensing portion cap 200 and the temperature sensing portion 73 is weakened, resulting in product variation (instrumental error) between electronic thermometers.

### SUMMARY OF THE INVENTION

Preferred embodiments of the present invention provide a temperature sensing portion cap and an electronic thermometer that are provided with a structure that secure thermal bonding between the temperature sensing portion cap and a temperature sensing portion, significantly reduces or prevents variation in the fixing position of the temperature sensing portion and thermal diffusion, through the packing of adhesive.

A temperature sensing portion cap according to a preferred embodiment of the present invention is preferably for use with an electronic thermometer, the electronic thermometer being provided with a hollow main body housing including an opening portion at a tip, a temperature sensing portion that is drawn from inside the main body housing to outside the main body housing through the opening portion by a lead, and the temperature sensing portion cap that accommodates the temperature sensing portion and occludes the opening portion, the temperature sensing portion cap including a tubular or substantially tubular body portion that is located toward the opening portion of the main body housing, and a bottomed accommodating portion that is in communication with the body portion and accommodates the temperature sensing portion. A temperature sensing portion supporting region is provided inside the accommodating portion, by an indented region that is indented toward the body portion located on a tip portion side of an outer surface of the accommodating portion.

According to another preferred embodiment of the present invention, the inside of the accommodating portion is divided into two or more temperature sensing portion supporting regions by the indented region, and the temperature sensing portion is accommodated in one of the temperature sensing portion supporting regions.

According to another preferred embodiment of the present invention, the indented region includes a linear recessed groove that is recessed toward the body portion from the tip portion side of the accommodating portion, and the accommodating portion is divided into two or more temperature sensing portion supporting regions by the recessed groove.

According to another preferred embodiment of the present invention, the indented region includes a tubular or substantially tubular recessed groove that is recessed toward the body portion from a central tip portion side of the accommodating portion, and the temperature sensing portion supporting region is annularly arranged inside the accommodating portion by the recessed groove.

According to another preferred embodiment of the present invention, the temperature sensing portion supporting region which narrows toward the tip portion is defined in an inner space of the accommodating portion by the indented region, and the temperature sensing portion is accommodated in the tip portion of the temperature sensing portion supporting region.

According to another preferred embodiment of the present invention, the indented region includes a first inclined surface that is located toward the body portion and has a first inclination angle and a second inclined surface that is located toward the tip portion and has a second inclination angle that is greater than the first inclination angle, and the temperature sensing portion is accommodated in the tip portion of the temperature sensing portion supporting region which is partitioned by the second inclined surface.

According to another preferred embodiment of the present invention, the indented region includes an inclined surface that has a predetermined inclination angle, and the temperature sensing portion is accommodated in the tip portion of the temperature sensing portion supporting region which is partitioned by the inclined surface.

An electronic thermometer according to a preferred embodiment of the present invention includes a hollow main body housing including an opening portion at a tip, a temperature sensing portion that is drawn from inside the main body housing to outside the main body housing through the opening portion by a lead, and a temperature sensing portion cap that accommodates the temperature sensing portion and occludes the opening portion, the temperature sensing portion cap being a temperature sensing portion cap according to one of the preferred embodiments of the present invention described above.

According to another preferred embodiment of the present invention, the main body housing includes a display unit, and a display surface of the display unit faces in a direction rotated approximately 90 degrees from the temperature sensing portion, when the temperature sensing portion cap is seen from a tip side.

Various preferred embodiments of the present invention enables provision of a temperature sensing portion cap and an electronic thermometer that are provided with a structure that secures thermal bonding between the temperature sensing portion cap and a temperature sensing portion, significantly reduces or prevents variation in the fixing position of the temperature sensing portion and thermal diffusion, through the packing of adhesive.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view showing the outer structure of an electronic thermometer according to Preferred Embodiment 1 of the present invention.

FIG. 2 shows the configuration of functional blocks of the electronic thermometer according to Preferred Embodiment 1 of the present invention.

FIG. 3 is an exploded perspective view showing the assembly structure of the electronic thermometer according to Preferred Embodiment 1 of the present invention.

FIG. 4 is a perspective view showing the outer structure of a temperature sensing portion cap of Preferred Embodiment 1 of the present invention.

FIGS. 5A-5C show the outer structure of the temperature sensing portion cap of Preferred Embodiment 1, with FIG. 5A being a front view, FIG. 5B being a side view and FIG. 5C being a bottom view taken from the tip.

FIG. 6 is a cross-sectional view taken in the direction of arrows VI-VI in FIG. 5B.

FIG. 7 is a perspective view showing the outer structure of a temperature sensing portion cap of Preferred Embodiment 2 of the present invention.

FIGS. 8A-8C show the outer structure of the temperature sensing portion cap of Preferred Embodiment 2, with FIG. 8A being a front view, FIG. 8B being a side view and FIG. 8C being a bottom view taken from the tip.

FIG. 9 is a cross-sectional view taken in the direction of arrows IX-IX in FIG. 8C.

FIG. 10 is a perspective view showing the outer structure of a temperature sensing portion cap of Preferred Embodiment 3 of the present invention.

FIGS. 11A-11C show the outer structure of the temperature sensing portion cap of Preferred Embodiment 3, with FIG. 11A being a front view, FIG. 11B being a side view and FIG. 11C being a bottom view taken from the tip.

FIG. 12 is a cross-sectional view taken in the direction of arrows XII-XII in FIG. 11B.

FIG. 13 is a perspective view showing the outer structure of a temperature sensing portion cap of Preferred Embodiment 4 of the present invention.

FIGS. 14A and 14B show the outer structure of the temperature sensing portion cap of Preferred Embodiment 4, with FIG. 14A being a front view and FIG. 14B being a side view.

FIG. 15 is a cross-sectional view taken in the direction of arrows XV-XV in FIG. 14B.

FIG. 16 is a perspective view showing the outer structure of a temperature sensing portion cap of Preferred Embodiment 5 of the present invention.

FIGS. 17A and 17B show the outer structure of the temperature sensing portion cap of Preferred Embodiment 5, with FIG. 17A being a front view and FIG. 17B being a side view.

FIG. 18 is a cross-sectional view taken in the direction of arrows XVIII-XVIII in FIG. 17B.

FIG. 19 is a perspective view showing the outer structure of a temperature sensing portion cap of the background art.

FIG. 20 is a longitudinal sectional view of the temperature sensing portion cap of the background art.

FIG. 21 is a longitudinal sectional view showing a method of fixing a temperature sensing portion to the temperature sensing portion cap of the background art, by packing the temperature sensing portion cap with adhesive.

FIG. 22 is a longitudinal sectional view showing a method of fixing a temperature sensing portion to the temperature sensing portion cap of the background art, by using adhesive on a portion of the temperature sensing portion cap.

### DETAILED DESCRIPTION OF THE PREFERRED EMBODIMENTS

Hereinafter, a temperature sensing portion cap according to preferred embodiments of the present invention will be described in detail with reference to the drawings. Note that, in the case where numbers, amounts or the like are referred to in the following preferred embodiments, the scope of the present invention is not necessary limited to those numbers, amounts or the like, unless expressly stated otherwise. Note also that, in the multiple preferred embodiments described hereinafter, appropriately combining the configurations of individual preferred embodiments was intended from the outset, unless expressly stated otherwise. The same reference numerals in the drawings indicate the same or equivalent portions, and redundant description may not be reiterated.

### Preferred Embodiment 1

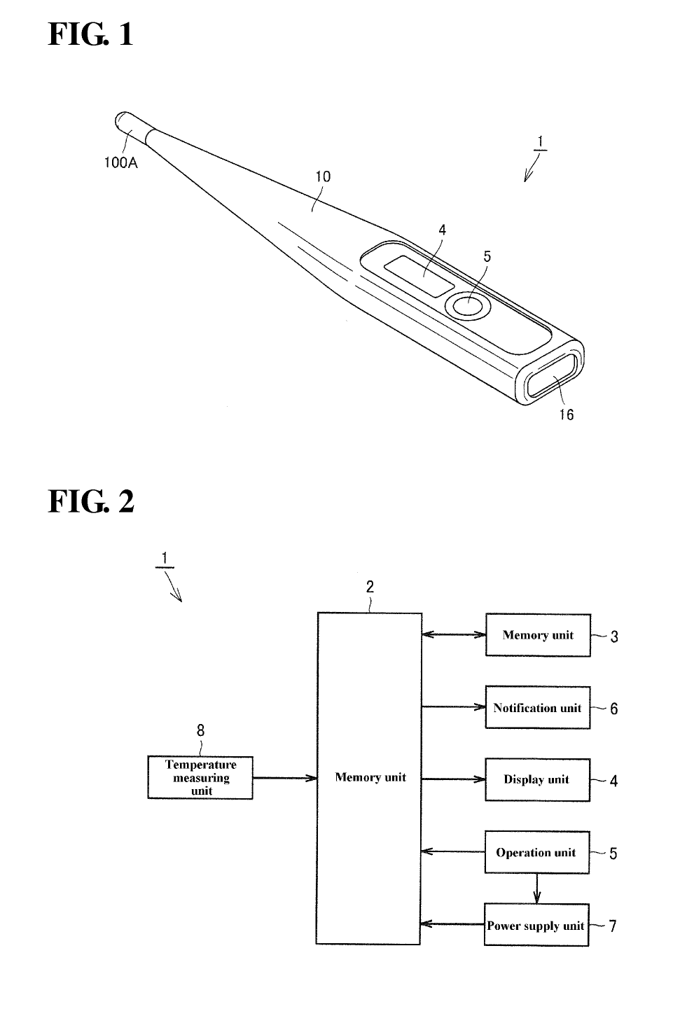

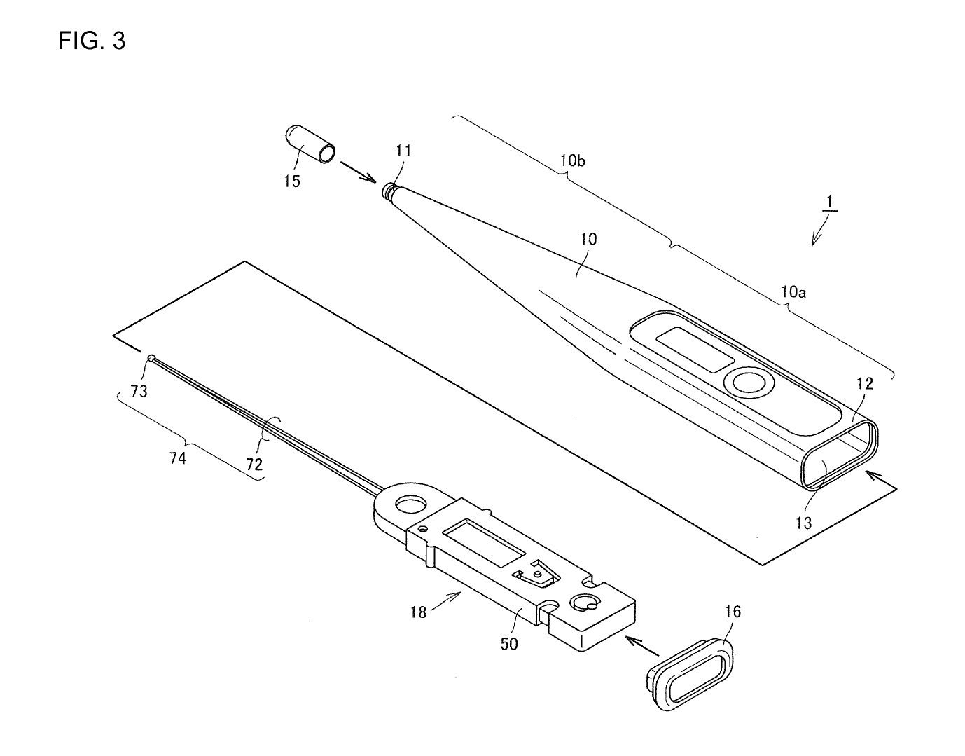

A schematic configuration of an electronic thermometer 1 in the present preferred embodiment will be described, with reference to FIGS. 1 to 3. FIG. 1 is a perspective view showing the outer structure of the electronic thermometer 1 in Preferred Embodiment 1 of the present invention, FIG. 2 shows the configuration of functional blocks of the electronic thermometer 1 shown in FIG. 1, and FIG. 3 is an exploded perspective view showing the assembly structure of the electronic thermometer.

As shown in FIG. 1, the electronic thermometer 1 in the present preferred embodiment is provided with a main body housing 10, a temperature sensing portion cap 100A serving as a temperature measuring unit, and an occluding member 16. The main body housing 10 is a hollow tubular member made of a resin material such as acrylonitrile butadiene styrene (ABS) resin, for example.

A face plate is stuck on a predetermined position of the surface of the main body housing 10, and a display unit 4 and an operation unit 5 are provided on predetermined positions of the surface of the face plate. The temperature sensing portion cap 100A is a bottomed tubular member that is occluded at one end. The temperature sensing portion cap 100A is formed with an arbitrary material, examples of which include a metal material such as stainless alloy and a resin material. The occluding member 16 is a block-shaped member preferably made of a resin material such as ABS resin, for example.

As shown in FIG. 3, the temperature sensing portion cap 100A is attached to an opening portion 11 that defines one end of the main body housing 10 in the axial direction (longitudinal direction). The occluding member 16 is attached to aback end portion 12 that defines the other end of the main body housing 10 in the axial direction (longitudinal direction). The casing of the electronic thermometer 1 of the present preferred embodiment includes the main body housing 10, the temperature sensing portion cap 100 disposed at the tip of the main body housing 10, and the occluding member 16 disposed at the back end of the main body housing 10.

As shown in FIG. 2, the electronic thermometer 1 in the present preferred embodiment is provided with a control unit 2, a memory unit 3, a notification unit 6, a power supply unit 7, and a temperature measuring unit 8, in addition to the display unit 4 and the operation unit 5 mentioned above. The control unit 2 is constituted by a central processing unit (CPU), for example, and is programmed to perform overall control of the electronic thermometer 1.

The memory unit 3 is constituted by a read only memory (ROM) or a random access memory (RAM), for example, and stores a program to cause the control unit 2 or the like to execute a processing procedure to measure body temperature, and to store measurement results and the like.

The display unit 4 is constituted by a display panel such as a liquid crystal display (LCD), for example, and displays measurement results and the like. The operation unit 5 includes push buttons, for example, and is arranged to receive operations by a user and input external commands to the control unit 2, the power supply unit 7, and the like. The notification unit 6 is constituted by a buzzer, for example, and provides notification to the user that measurement has ended, operations by the user have been received, and the like.

The power supply unit 7 is constituted by a button cell, for example, and is supplies electric power as the power supply to the control unit 2. The temperature measuring unit 8 is a site that includes the abovementioned temperature sensing portion cap 100A and the temperature sensing portion 73 accommodated inside the temperature sensing portion cap 100A, and detects body temperature by being placed in a measurement site such as in the armpit or under the tongue.

The control unit 2 includes a processing circuit arranged and programmed to execute body temperature measurement, and measures body temperature based on a program read from the memory unit 3. At this time, the control unit 2 calculates body temperature as a measurement result by processing temperature data input from the temperature measuring unit 8. The control unit 2 further controls the electronic thermometer 1, so as to display the calculated body temperature on the display unit 4, store the calculated body temperature in the memory unit 3, inform the user that measurement has ended using the notification unit 6, and the like.

Referring again to FIG. 3, the electronic thermometer 1 in the present preferred embodiment is provided with the main body housing 10, the temperature sensing portion cap 100 and the occluding member 16 as the casing mentioned above, and an assembly 18 as a subassembly to which various internal constituent components are attached. The main body housing 10 includes a hollow main body portion 10a that accommodates the assembly 18, and a hollow probe portion 10b that is disposed between the temperature sensing portion cap 100 defining the temperature measuring unit and the main body portion 10a.

The temperature sensing portion 73 and the leads 72 define a radial lead thermistor (temperature sensor) 74 in which the leads 72 extend parallel or substantially parallel in the same direction. Note that although the shape of the temperature sensing portion 73 is illustrated as preferably being a chip type in FIG. 3, the present invention is not limited thereto, and the temperature sensing portion 73 can be teardrop shaped or other suitable shape, for example. This also applies in the following preferred embodiments.

The temperature sensing portion cap 100A is fixed to the opening portion 11 defining the front end of the main body housing 10 by adhesion, for example. The assembly 18 is accommodated in a hollow portion 13 inside the main body housing 10, by being inserted through the opening in the back end portion 12 of the main body housing 10.

The occluding member 16 is fixed to the main body housing 10 by adhesion, ultrasonic welding or the like, for example, so as to occlude the opening in the back end portion 12 of the main body housing 10. Here, using ultrasonic welding to fix the occluding member 16 to the main body housing 10 enables processing to be performed in a short time, compared with when adhesion is used.

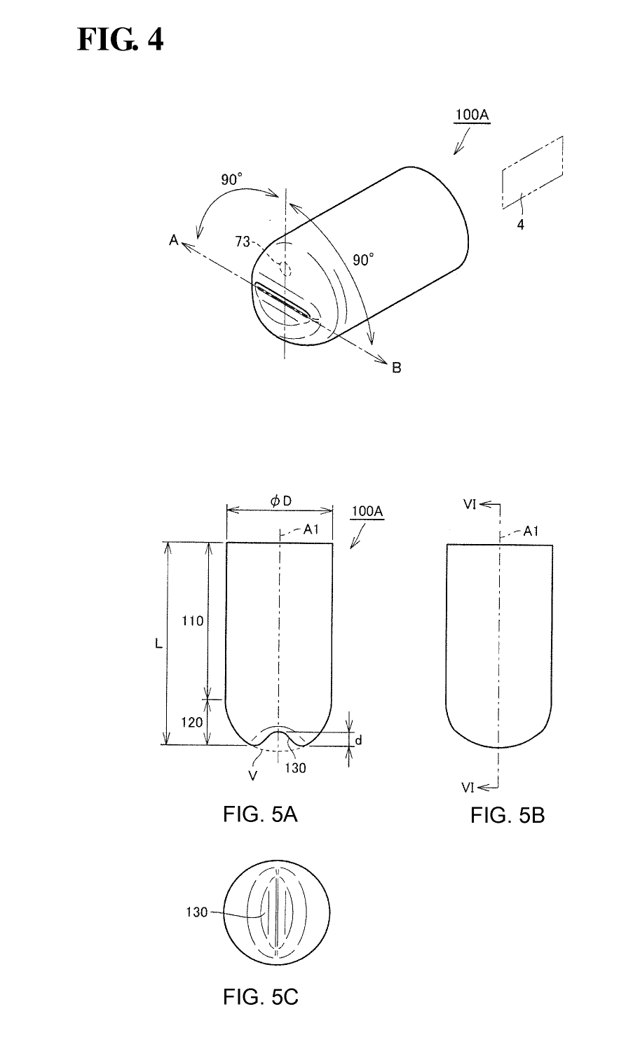

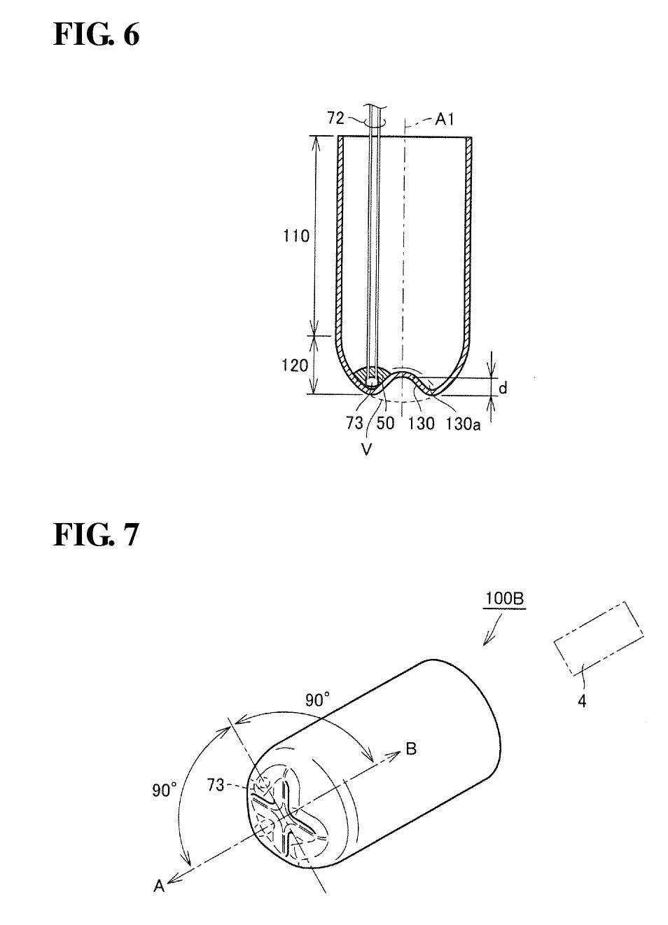

Next, a detailed structure of the temperature sensing portion cap 100A in the present preferred embodiment will be described, with reference to FIGS. 4 to 6. Note that FIG. 4 is a perspective view showing the outer structure of the temperature sensing portion cap 100A, FIGS. 5A-5C show the outer structure of the temperature sensing portion cap 100A, with FIG. 5A being a front view, FIG. 5B being a side view and FIG. 5C being a bottom view taken from the tip, and FIG. 6 is a cross-sectional view taken in the direction of arrows VI-VI in FIG. 5B. Note also that, in FIG. 4, only the display portion 4 is schematically illustrated for convenience of description.

The temperature sensing portion cap 100A includes a tubular or substantially tubular body portion 110 that is located toward the opening portion 11 of the main body housing 10, and a bottomed accommodating portion 120 that is in communication with the body portion 110 and accommodates the temperature sensing portion 73. The temperature sensing portion cap 100A is preferably made of a metal material such as stainless steel of about 0.1-0.5 mm in thickness, and has a U-shaped cross-section, for example. The temperature sensing portion cap 100A preferably has a length (L) of approximately 7-11 mm, the body portion 110 preferably has a diameter (ΦD) of approximately 3-5 mm, the accommodating portion 120 preferably has a length (ΦD/2) of approximately 1.5-2.5 mm, and the body portion 110 preferably has a length of (L)−(ΦD/2), for example.

In the accommodating portion 120, an indented region 130 that is indented toward the body portion 110 is provided on the tip portion side of the outer surface thereof. The indented region 130 in the present preferred embodiment preferably is shaped like a minus screw head. Here, the indented region 130 denotes a region that is located toward the body portion 110 relative to a virtual curved surface V of the accommodating portion 120 assuming that the indented region 130 is not provided. The indented region 130 in the present preferred embodiment preferably has the shape of a recessed linear groove that is recessed toward the body portion 110 from the tip portion side of the accommodating portion 120. The indented region 130 preferably has a depth (d) of approximately 0.5-2.0 mm, for example.

Temperature sensing portion supporting regions 130a are provided inside the accommodating portion 120, by providing the indented region 130 in the outer surface of the accommodating portion 120. Specifically, as a result of the indented region 130, a raised portion is provided inside the accommodating portion 120, and the inside of the accommodating portion 120 is divided by the raised portion into two temperature sensing portion supporting regions 130a, across a central axis A1.

Also, as clearly shown in FIG. 6, the temperature sensing portion 73 of the thermistor (temperature sensor) 74 is accommodated in one of the temperature sensing portion supporting regions 130a into which the inside of the accommodating portion 120 is divided, and is fixed using the adhesive 50.

According to the temperature sensing portion cap 100A in the present preferred embodiment and the electronic thermometer 1 including the temperature sensing portion cap 100A, the temperature sensing portion supporting regions 130a result in the wall surface of the accommodating portion 120 being located so as to surround the temperature sensing portion 73, and when inserted into the accommodating portion 120 of the temperature sensing portion cap 100A, the temperature sensing portion 73 of the thermistor (temperature sensor) 74 reaches one of the temperature sensing portion supporting regions 130a. The temperature sensing portion 73 can thus be easily positioned relative to the temperature sensing portion supporting regions 130a with a small amount of adhesive 50.

Also, since the adhesive 50 can be disposed between the wall surface of the accommodating portion 120 and the temperature sensing portion 73 so as to surround the temperature sensing portion 73, an adhesion surface with the adhesive 50 can be secured over substantially the entire surface of the temperature sensing portion 73 even when the amount of adhesive 50 is small, and fixing of the temperature sensing portion 73 to the accommodating portion 120 can be stabilized.

As a result, it is possible to secure thermal bonding between the temperature sensing portion cap 100A and the temperature sensing portion 73, significantly reduce or prevent variation in the fixing position of the temperature sensing portion 73 and thermal diffusion, through the packing of adhesive 50.

Also, given that fixing of the temperature sensing portion 73 to the accommodating portion 120 can be stabilized, omission of thermal response testing for checking for variation in the fixed state of the temperature sensing portion 73 after assembly of the electronic thermometer 1 can be anticipated.

Also, given that the amount of adhesive 50 is small, heat is quickly transferred from the temperature sensing portion cap 100A to the temperature sensing portion 73, enabling use as a fast measurement electronic thermometer to be anticipated. Also, since the accommodating portion does not need to be constituted using any small resin parts in addition to the temperature sensing portion cap 100A, there no increase in production cost.

Referring again to FIG. 4, note that in the case where the electronic thermometer is placed in the subject's armpit, it is better for the temperature sensing portion 73 to be positioned on either the arm side (upper arm side) or the body side of the subject. In view of this, the display surface of the display unit 4 of the electronic thermometer preferably faces in a direction rotated approximately 90 degrees from the temperature sensing portion 73 (A or B direction in the diagram), when the temperature sensing portion cap 100A is seen from the tip side.

Given that the subject places the electronic thermometer in his or her armpit so as to be in a position that allows the display surface of the display unit 4 of the electronic thermometer to be seen, it is possible to ensure that the temperature sensing portion 73 is positioned on either the arm side (upper arm side) or the body side of the subject, irrespective of whether the subject places the electronic thermometer in his or her left armpit or right armpit.

### Preferred Embodiment 2

Next, an electronic thermometer and a temperature sensing portion cap in Preferred Embodiment 2 will be described with reference to the drawings. Note that the basic configuration of the electronic thermometer is preferably the same or substantially the same as Preferred Embodiment 1, the only difference being the shape of the temperature sensing portion cap. Accordingly, only the shape of the temperature sensing portion cap in the present preferred embodiment will be described in detail here.

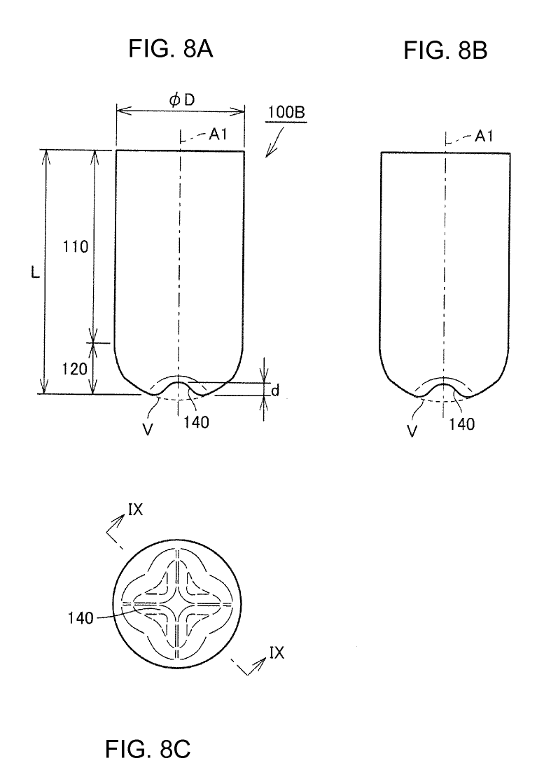

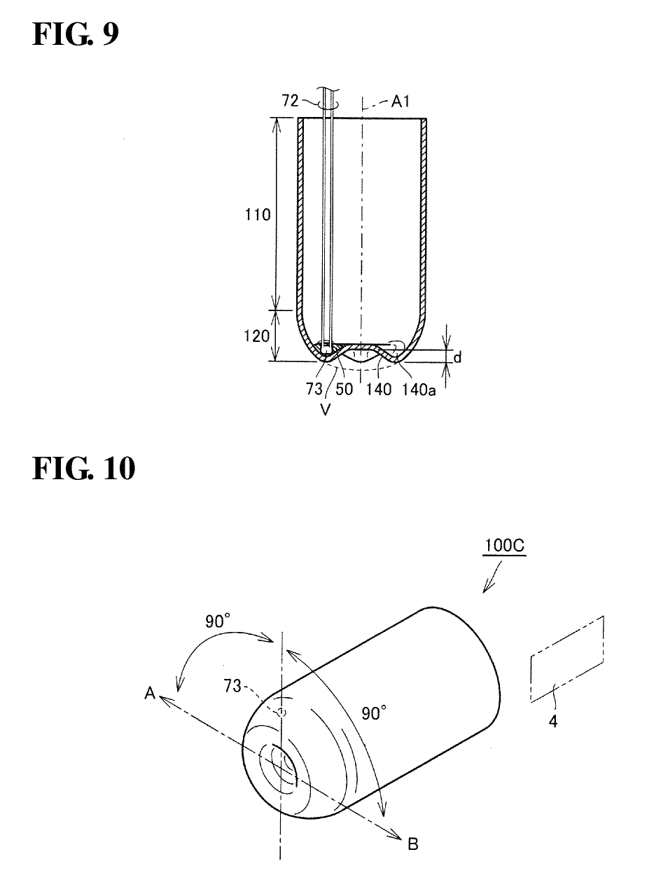

A detailed structure of the temperature sensing portion cap 100B in the present preferred embodiment will be described, with reference to FIGS. 7 to 9. Note that FIG. 7 is a perspective view of the outer structure of the temperature sensing portion cap 100B, FIGS. 8A-8C show the outer structure of the temperature sensing portion cap 100B, with FIG. 8A being a front view, FIG. 8B being a side view and FIG. 8C being a bottom view, and FIG. 9 is a cross-sectional view taken in the direction of arrows IX-IX in FIG. 8. Note also that, in FIG. 7, only the display unit 4 is schematically illustrated for convenience of description.

This temperature sensing portion cap 100B includes a tubular or substantially tubular body portion 110 that is located toward the opening portion 11 of the main body housing 10, and a bottomed accommodating portion 120 that is in communication with the body portion 110 and accommodates the temperature sensing portion 73, similarly to the temperature sensing portion cap 100A in Preferred Embodiment 1. The temperature sensing portion cap 100B is preferably made of a metal material such as stainless steel of about 0.1-0.5 mm in thickness, and has a U-shaped cross-section. The temperature sensing portion cap 100B preferably has a length (L) of approximately 7-11 mm, the body portion 110 preferably has a diameter (ΦD) of approximately 3-5 mm, the accommodating portion 120 preferably has a length (ΦD/2) of approximately 1.5-2.5 mm, and the body portion 110 preferably has a length of (L)−(ΦD/2), for example.

In the accommodating portion 120, an indented region 140 that is indented toward the body portion 110 is provided on the tip portion side of the outer surface thereof. The indented region 140 in the present preferred embodiment is shaped like a plus screw head. Here, the indented region 140 denotes a region that is located toward the body portion 110 relative to a virtual curved surface V of the accommodating portion 120 assuming that the indented region 140 is not provided. The indented region 140 in the present preferred embodiment preferably has the shape of a recessed cross-shaped groove that is recessed toward the body portion 110 from the tip portion side of the accommodating portion 120. The indented region 140 preferably has a depth (d) of approximately 0.5-2.0 mm, for example.

Temperature sensing portion supporting regions 140a are provided inside the accommodating portion 120, by providing the indented region 140 in the outer surface of the accommodating portion 120. Specifically, as a result of the indented region 140, a raised portion is provided inside the accommodating portion 120. The inside of the accommodating portion 120 is divided by the raised portion into four temperature sensing portion supporting regions 140a, so as to surround a central axis A1.

Also, as is clearly shown in FIG. 9, the temperature sensing portion 73 of the thermistor (temperature sensor) 74 is accommodated in one of the temperature sensing portion supporting regions 140a into which the inside of the accommodating portion 120 is divided, and is fixed using the adhesive 50.

According to the temperature sensing portion cap 100B in the present preferred embodiment and an electronic thermometer including the temperature sensing portion cap 100B, the temperature sensing portion supporting regions 140a result in the wall surface of the accommodating portion 120 being located so as to surround the temperature sensing portion 73, and when inserted into the accommodating portion 120 of the temperature sensing portion cap 100B, the temperature sensing portion 73 of the thermistor (temperature sensor) 74 reaches one of the temperature sensing portion supporting regions 140a. The temperature sensing portion 73 can thus be easily positioned relative to the temperature sensing portion supporting regions 140a with a small amount of adhesive 50.

Also, since the adhesive 50 can be disposed between the wall surface of the accommodating portion 120 and the temperature sensing portion 73 so as to surround the temperature sensing portion 73, an adhesion surface with the adhesive 50 can be secured over substantially the entire surface of the temperature sensing portion 73 even when amount of adhesive 50 is small, and fixing of the temperature sensing portion 73 to the accommodating portion 120 can be stabilized.

As a result, it is possible to secure thermal bonding between the temperature sensing portion cap 100B and the temperature sensing portion 73, significantly reduce or prevent variation in the fixing position of the temperature sensing portion 73 and thermal diffusion, through the packing of adhesive 50.

Also, given that fixing of the temperature sensing portion 73 to the accommodating portion 120 can be stabilized, omission of thermal response testing for checking for variation in the fixed state of the temperature sensing portion 73 after assembly of the electronic thermometer 1 can be anticipated.

Also, given that the amount of adhesive 50 is small, heat is quickly transferred from the temperature sensing portion cap 100B to the temperature sensing portion 73, enabling use as a fast measurement electronic thermometer to be anticipated. Also, since the accommodating portion does not need to be constituted using any small resin parts in addition to the temperature sensing portion cap 100B, there no increase in production cost.

Referring again to FIG. 7, note that in the case where the electronic thermometer is placed in the subject's armpit, it is better for the temperature sensing portion 73 to be positioned on either the arm side (upper arm side) or the body side of the subject. In view of this, the display surface of the display unit 4 of the electronic thermometer preferably faces in a direction rotated approximately 90 degrees from the temperature sensing portion 73 (A or B direction in the diagram), when the temperature sensing portion cap 100B is seen from the tip side.

Given that the subject places the electronic thermometer in his or her armpit so as to be in a position that allows the display surface of the display unit 4 of the electronic thermometer to be seen, it is possible to ensure that the temperature sensing portion 73 is positioned on either the arm side (upper arm side) or the body side of the subject, irrespective of whether the subject places the electronic thermometer in his or her left armpit or right armpit.

### Preferred Embodiment 3

Next, an electronic thermometer and a temperature sensing portion cap in Preferred Embodiment 3 will be described, with reference to the drawings. Note that the basic configuration of the electronic thermometer is preferably the same or substantially the same as Preferred Embodiment 1, the only difference being the shape of the temperature sensing portion cap. Accordingly, only the shape of the temperature sensing portion cap in the present preferred embodiment will be described in detail here.

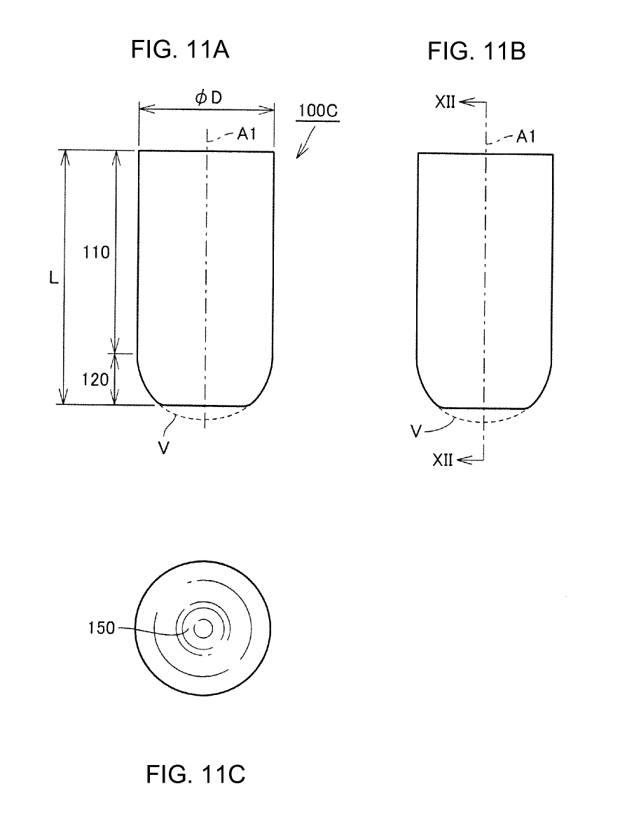

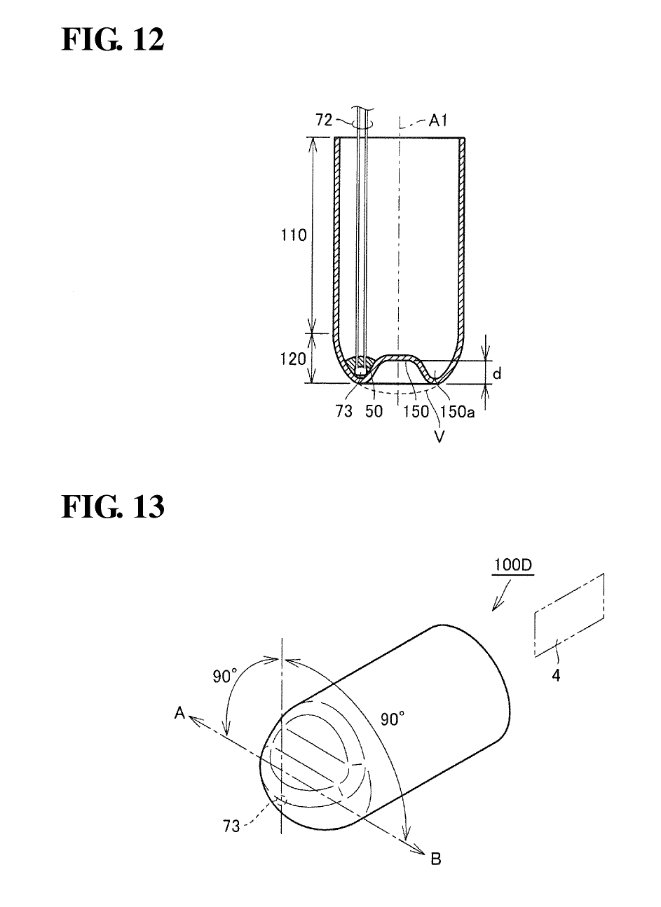

A detailed structure of the temperature sensing portion cap 100C in the present preferred embodiment will be described, with reference to FIGS. 10 to 12. Note that FIG. 10 is a perspective view of the outer structure of the temperature sensing portion cap 100C, FIGS. 11A-11C show the outer structure of the temperature sensing portion cap 100C, with FIG. 11A being a front view, FIG. 11B being a side view and FIG. 11C being a bottom view, and FIG. 12 is a cross-sectional view taken in the direction of arrows XII-XII in FIG. 11B. Note also that, in FIG. 10, only the display unit 4 is schematically illustrated for convenience of description.

This temperature sensing portion cap 100C includes a tubular or substantially tubular body portion 110 that is located toward the opening portion 11 of the main body housing 10, and a bottomed accommodating portion 120 that is in communication with this body portion 110 and accommodates the temperature sensing portion 73, similarly to the temperature sensing portion cap 100A in Preferred Embodiment 1. The temperature sensing portion cap 100C is preferably made of a metal material such as stainless steel of about 0.1-0.5 mm in thickness, and has a U-shaped cross-section, for example. The temperature sensing portion cap 100C preferably has a length (L) of approximately 7-11 mm, the body portion 110 preferably has a diameter (ΦD) of approximately 3-5 mm, the accommodating portion 120 preferably has a length (ΦD/2) of approximately 1.5-2.5 mm, and the body portion 110 preferably has a length of (L)−(ΦD/2), for example.

In the accommodating portion 120, an indented region 150 that is indented toward the body portion 110 is provided on the tip portion side of the outer surface thereof. Here, the indented region 150 denotes a region that is located toward the body portion 110 relative to a virtual curved surface V of the accommodating portion 120 assuming that the indented region 150 is not provided. The indented region 150 in the present preferred embodiment preferably has the shape of a recessed tubular groove that is recessed toward the body portion 110 from a central tip portion side of the accommodating portion 120. The indented region 150 preferably has a depth (d) of approximately 0.5-2.0 mm, for example.

A temperature sensing portion supporting region 150a is provided inside the accommodating portion 120, by providing the indented region 150 in the outer surface of the accommodating portion 120. Specifically, an annular temperature sensing portion supporting region 150a that surrounds a central axis A1 is provided inside the accommodating portion 120 by the indented region 150.

Also, as clearly shown in FIG. 12, the temperature sensing portion 73 of the thermistor (temperature sensor) 74 is accommodated in the annular temperature sensing portion supporting region 150a into which the inside of the accommodating portion 120 is divided, and is fixed using the adhesive 50.

According to the temperature sensing portion cap 100C in the present preferred embodiment and an electronic thermometer including this temperature sensing portion cap 100C, the temperature sensing portion supporting region 150a results in the wall surface of the accommodating portion 120 being located so as to surround the temperature sensing portion 73, and when inserted into the accommodating portion 120 of the temperature sensing portion cap 100C, the temperature sensing portion 73 of the thermistor (temperature sensor) 74 reaches the annular temperature sensing portion supporting region 150a. The temperature sensing portion 73 can thus be easily positioned relative to the temperature sensing portion supporting regions 150a with a small amount of adhesive 50.

Also, since the adhesive 50 can be disposed between the wall surface of the accommodating portion 120 and the temperature sensing portion 73 so as to surround the temperature sensing portion 73, an adhesion surface with the adhesive 50 can be secured over substantially the entire surface of the temperature sensing portion 73 even when the amount of adhesive 50 is small, and fixing of the temperature sensing portion 73 to the accommodating portion 120 can be stabilized.

As a result, it is possible to secure thermal bonding between the temperature sensing portion cap 100C and the temperature sensing portion 73, significantly reduce or prevent variation in the fixing position of the temperature sensing portion 73 and thermal diffusion, through the packing of adhesive 50.

Also, given that fixing of the temperature sensing portion 73 to the accommodating portion 120 can be stabilized, omission of thermal response testing for checking for variation in the fixed state of the temperature sensing portion 73 after assembly of the electronic thermometer 1 can be anticipated.

Also, given that the amount of adhesive 50 is small, heat is quickly transferred from the temperature sensing portion cap 100C to the temperature sensing portion 73, enabling use as a fast measurement electronic thermometer to be anticipated. Also, since the accommodating portion does not need to be constituted using any small resin parts in addition to the temperature sensing portion cap 100C, there no increase in production cost.

Referring again to FIG. 10, note that in the case where the electronic thermometer is placed in the subject's armpit, it is better for the temperature sensing portion 73 to be positioned on either the arm side (upper arm side) or the body side of the subject. In view of this, the display surface of the display unit 4 of the electronic thermometer preferably faces in a direction rotated approximately 90 degrees from the temperature sensing portion 73 (A or B direction in the diagram), when the temperature sensing portion cap 100C is seen from the tip side.

Given that the subject places the electronic thermometer in his or her armpit so as to be in a position that allows the display surface of the display unit 4 of the electronic thermometer to be seen, it is possible to ensure that the temperature sensing portion 73 is positioned on either the arm side (upper arm side) or the body side of the subject, irrespective of whether the subject places the electronic thermometer in his or her left armpit or right armpit.

### Preferred Embodiment 4

Next, an electronic thermometer and a temperature sensing portion cap in Preferred Embodiment 4 will be described, with reference to the drawings. Note that the basic configuration of the electronic thermometer is preferably the same or substantially the same as Preferred Embodiment 1, the only difference being the shape of the temperature sensing portion cap. Accordingly, only the shape of the temperature sensing portion cap in the present preferred embodiment will be described in detail here.

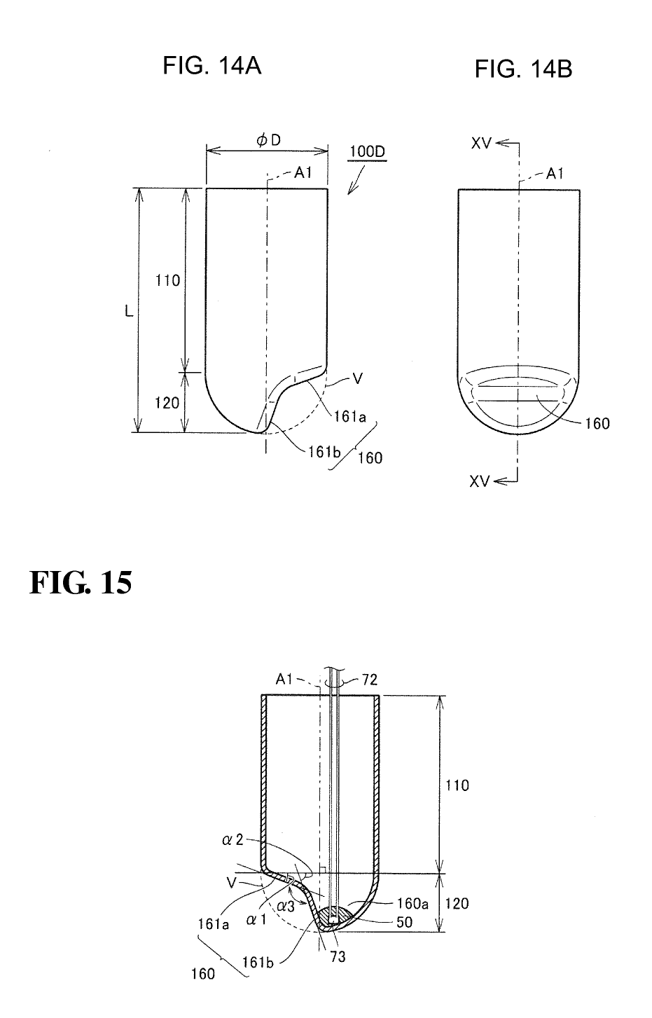

A detailed structure of the temperature sensing portion cap 100D in the present preferred embodiment will be described, with reference to FIGS. 13 to 15. Note that FIG. 13 is a perspective view showing the outer structure of the temperature sensing portion cap 100D, FIGS. 14A and 14B show the outer structure of the temperature sensing portion cap 100D, with FIG. 14A being a front view and FIG. 14B being a side view, and FIG. 15 is a cross-sectional view taken in the direction of arrows XV-XV in FIG. 14B. Note also that, in FIG. 13, only the display unit 4 is schematically illustrated for convenience of description.

The temperature sensing portion cap 100D includes a tubular or substantially tubular body portion 110 that is located toward the opening portion 11 of the main body housing 10, and a bottomed accommodating portion 120 that is in communication with the body portion 110 and accommodates the temperature sensing portion 73, similarly to the temperature sensing portion cap 100A in Preferred Embodiment 1. The temperature sensing portion cap 100D is preferably made of a metal material such as stainless steel of about 0.1-0.5 mm in thickness, and has a U-shaped cross-section, for example. The temperature sensing portion cap 100D preferably has a length (L) of approximately 7-11 mm, the body portion 110 preferably has a diameter (ΦD) of approximately 3-5 mm, the accommodating portion 120 preferably has a length (ΦD/2) of approximately 1.5-2.5 mm, and the body portion 110 preferably has a length of (L)−(ΦD/2), for example.

In the accommodating portion 120, an indented region 160 that is indented toward the body portion 110 is provided on the tip portion side of the outer surface thereof. Here, the indented region 160 denotes a region that is located toward the body portion 110 relative to a virtual curved surface V of the accommodating portion 120 assuming that the indented region 160 is not provided. The indented region 160 in the present preferred embodiment includes a first inclined surface 161a that is located toward the body portion 110 and has a first inclination angle (α1), and a second inclined surface 161b that is located toward the tip portion and has a second inclination angle (α2) greater than the first inclination angle (α1).

Here, the inclination angle denotes an angle defined when a virtual plane perpendicular to the central axis A1 intersects each inclined surface, as shown in FIG. 15. In the present preferred embodiment, the first inclination angle (α1) preferably is approximately 20 degrees, and the second inclination angle (α2) preferably is approximately 70 degrees, for example. Also, an intersection angle (α3) of the first inclined surface 161a and the second inclined surface 161b preferably is approximately 130 degrees, for example.

The temperature sensing portion 73 will thus be accommodated in the tip portion of a temperature sensing portion supporting region 160a defined by the second inclined surface 161b, as a result of the indented region 160 including the first inclined surface 161a and the second inclined surface 161b.

The temperature sensing portion supporting region 160a is provided inside the accommodating portion 120, by thus providing the indented region 160 in the outer surface of the accommodating portion 120. Specifically, the temperature sensing portion supporting region 160a is defined in the tip portion of the accommodating portion 120 by the indented region 160.

Also, as is clearly shown in FIG. 15, the temperature sensing portion 73 of the thermistor (temperature sensor) 74 is accommodated in the temperature sensing portion supporting region 160a into which the inside of the accommodating portion 120 is divided, and is fixed using the adhesive 50.

According to the temperature sensing portion cap 100D in the present preferred embodiment and an electronic thermometer including this temperature sensing portion cap 100D, the temperature sensing portion supporting region 160a results in the wall surface of the accommodating portion 120 being located so as to surround the temperature sensing portion 73, and when inserted into the accommodating portion 120 of the temperature sensing portion cap 100D, the temperature sensing portion 73 of the thermistor (temperature sensor) 74 reaches the tapered temperature sensing portion supporting region 160a. The temperature sensing portion 73 can thus be easily positioned relative to the temperature sensing portion supporting region 160a with a small amount of adhesive 50.

Also, since the adhesive 50 can be disposed between the wall surface of the accommodating portion 120 and the temperature sensing portion 73 so as to surround the temperature sensing portion 73, an adhesion surface with the adhesive 50 can be secured over substantially the entire surface of the temperature sensing portion 73 even when the amount of adhesive 50 is small, and fixing of the temperature sensing portion 73 to the accommodating portion 120 can be stabilized.

As a result, it is possible to secure thermal bonding between the temperature sensing portion cap 100D and the temperature sensing portion 73, significantly reduce or prevent variation in the fixing position of the temperature sensing portion 73 and thermal diffusion, through the packing of adhesive 50.

Also, given that fixing of the temperature sensing portion 73 to the accommodating portion 120 can be stabilized, omission of thermal response testing for checking for variation in the fixed state of the temperature sensing portion 73 after assembly of the electronic thermometer can be anticipated.

Also, given that the amount of adhesive 50 is small, heat is quickly transferred from the temperature sensing portion cap 100D to the temperature sensing portion 73, enabling use as a fast measurement electronic thermometer to be anticipated. Also, since the accommodating portion does not need to be constituted using any small resin parts in addition to the temperature sensing portion cap 100D, there no increase in production cost.

Referring again to FIG. 13, note that in the case where the electronic thermometer is placed in the subject's armpit, it is better for the temperature sensing portion 73 to be positioned on either the arm side (upper arm side) or the body side of the subject. In view of this, the display surface of the display unit 4 of the electronic thermometer preferably faces in a direction rotated approximately 90 degrees from the temperature sensing portion 73 (A or B direction in the diagram), when the temperature sensing portion cap 100D is seen from the tip side.

Given that the subject places the electronic thermometer in his or her armpit so as to be in a position that allows the display surface of the display unit 4 of the electronic thermometer to be seen, it is possible to ensure that the temperature sensing portion 73 is positioned on either the arm side (upper arm side) or the body side of the subject, irrespective of whether the subject places the electronic thermometer in his or her left armpit or right armpit.

### Preferred Embodiment 5

Next, an electronic thermometer and a temperature sensing portion cap in Preferred Embodiment 5 will be described, with reference to the drawings. Note that the basic configuration of the electronic thermometer preferably is the same or substantially the same as Preferred Embodiment 1, the only difference being the shape of the temperature sensing portion cap. Accordingly, only the shape of the temperature sensing portion cap in the present preferred embodiment will be described in detail here.

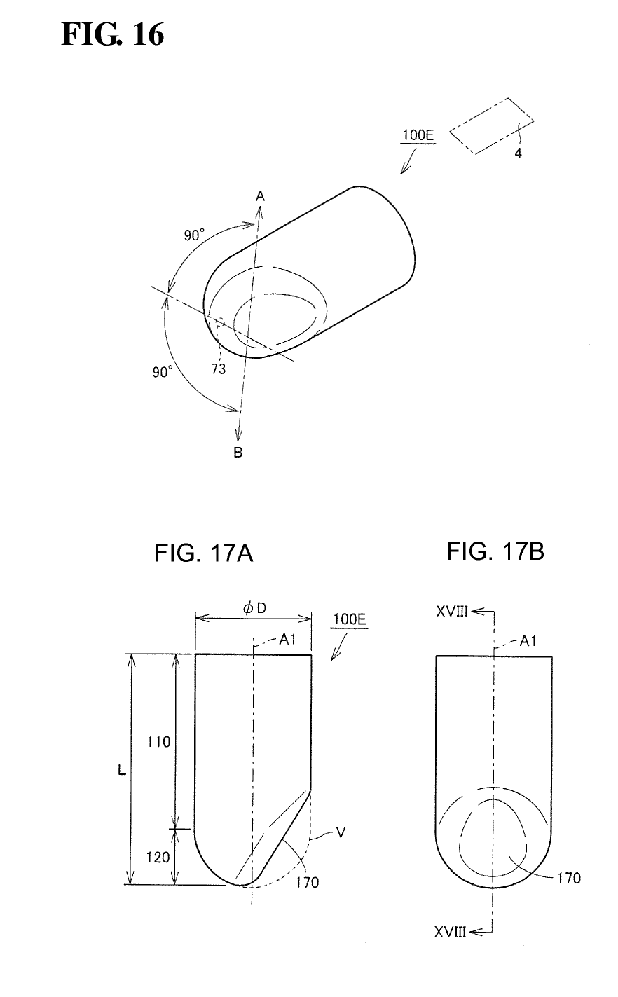

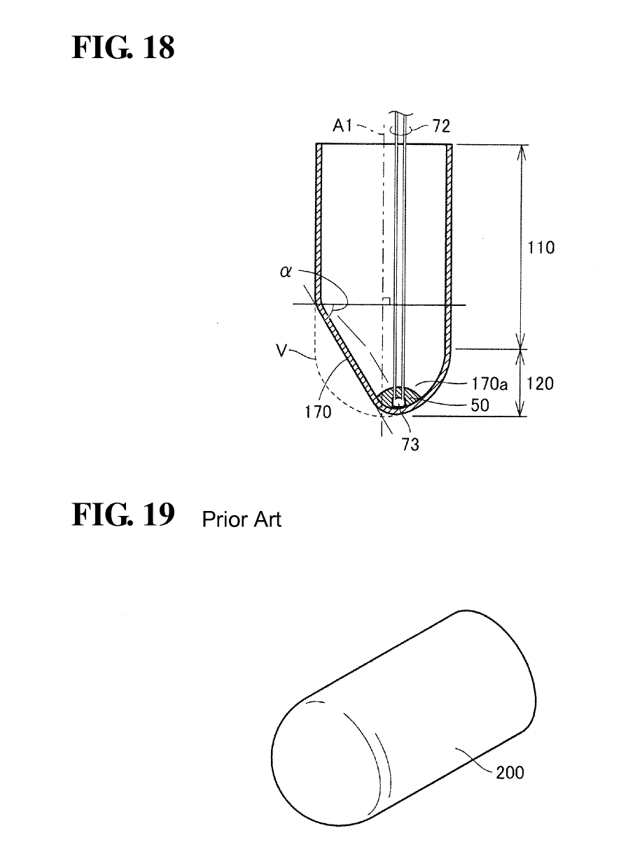

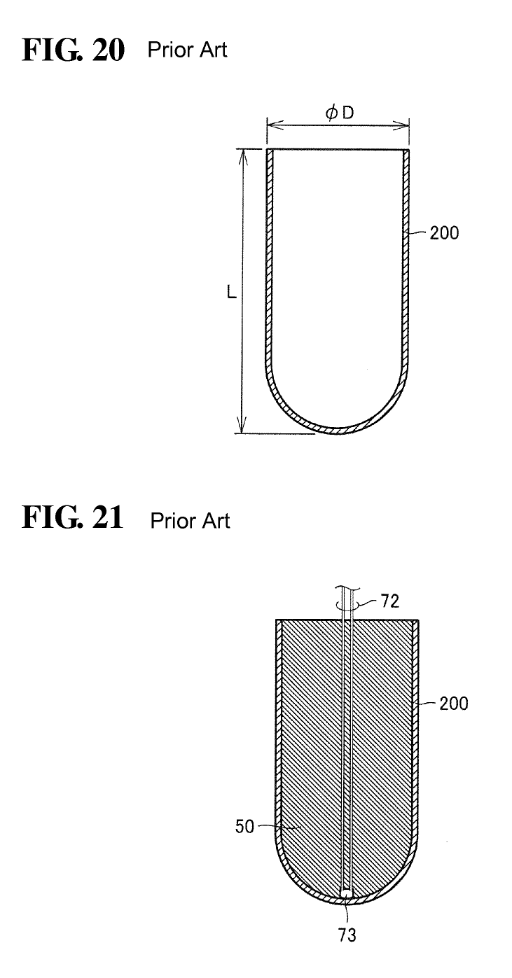

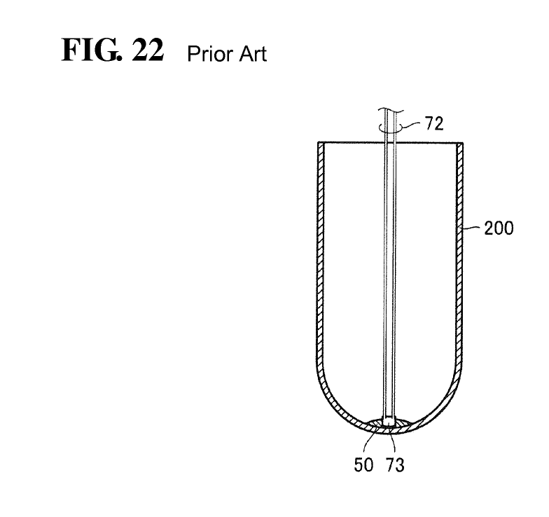

A detailed structure of the temperature sensing portion cap 100E in the present preferred embodiment will be described, with reference to FIGS. 16 to 18. Note that FIG. 16 is a perspective view showing the outer structure of the temperature sensing portion cap 100E, FIGS. 17A and 17B show the outer structure of the temperature sensing portion cap 100E, with FIG. 17A being a front view and FIG. 17B being a side view, and FIG. 18 is a cross-sectional view taken in the direction of arrows XVIII-XVIII in FIG. 17B. Note also that, in FIG. 16, only the display unit 4 is schematically illustrated for convenience of description.

The temperature sensing portion cap 100E includes a tubular or substantially tubular body portion 110 that is located toward the opening portion 11 of the main body housing 10, and a bottomed accommodating portion 120 that is in communication with the body portion 110 and accommodates the temperature sensing portion 73, similarly to the temperature sensing portion cap 100A in Preferred Embodiment 4. The temperature sensing portion cap 100E is preferably made of a metal material such as stainless steel of about 0.1-0.5 mm in thickness, and has a U-shaped cross-section, for example. The temperature sensing portion cap 100E preferably has a length (L) of approximately 7-11 mm, the body portion 110 preferably has a diameter (ΦD) of approximately 3-5 mm, the accommodating portion 120 preferably has a length (ΦD/2) of approximately 1.5-2.5 mm, and the body portion 110 preferably has a length of (L)−(ΦD/2).

In the accommodating portion 120, an indented region 170 that is indented toward the body portion 110 is provided on the tip portion side of the outer surface thereof. Here, the indented region 170 denotes a region that is located toward the body portion 110 relative to a virtual curved surface V of the accommodating portion 120 assuming that the indented region 170 is not provided. The indented region 170 in the present preferred embodiment includes an inclined surface that is located toward the body portion 110 and has a predetermined inclination angle (α).

Here, the inclination angle denotes an angle defined when a virtual plane perpendicular to the central axis A1 intersects the inclined surface, as shown in FIG. 18. In the present preferred embodiment, the inclination angle (α) is from approximately 45 degrees to approximately 90 degrees, and preferably is about 60 degrees, for example.

The temperature sensing portion 73 will thus be accommodated in the tip portion of a temperature sensing portion supporting region 170a partitioned by the indented region 170, as a result of the indented region 170 including an inclined surface.

The temperature sensing portion supporting region 170a is provided inside the accommodating portion 120, by thus providing the indented region 170 in the outer surface of the accommodating portion 120. Specifically, the temperature sensing portion supporting region 170a is provided in the tip portion of the accommodating portion 120 by the indented region 170.

Also, as is clearly shown in FIG. 18, the temperature sensing portion 73 of the thermistor (temperature sensor) 74 is accommodated in the temperature sensing portion supporting region 170a provided inside the accommodating portion 120, and is fixed using the adhesive 50.

According to the temperature sensing portion cap 100E in the present preferred embodiment and an electronic thermometer including this temperature sensing portion cap 100E, the temperature sensing portion supporting region 170a results in the wall surface of the accommodating portion 120 being located so as to surround the temperature sensing portion 73, and when inserted into the accommodating portion 120 of the temperature sensing portion cap 100E, the temperature sensing portion 73 of the thermistor (temperature sensor) 74 reaches the tapered temperature sensing portion supporting region 170a. The temperature sensing portion 73 can thus be easily positioned relative to the temperature sensing portion supporting region 170a with a small amount of adhesive 50.

Also, since the adhesive 50 can be disposed between the wall surface of the accommodating portion 120 and the temperature sensing portion 73 so as to surround the temperature sensing portion 73, an adhesion surface with the adhesive 50 can be secured over substantially the entire surface of the temperature sensing portion 73 even when the amount of adhesive 50 is small, and fixing of the temperature sensing portion 73 to the accommodating portion 120 can be stabilized.

As a result, it is possible to secure thermal bonding between the temperature sensing portion cap 100E and the temperature sensing portion 73, significantly reduce or prevent variation in the fixing position of the temperature sensing portion 73 and thermal diffusion, through the packing of adhesive 50.

Also, given that fixing of the temperature sensing portion 73 to the accommodating portion 120 can be stabilized, omission of thermal response testing for checking for variation in the fixed state of the temperature sensing portion 73 after assembly of the electronic thermometer can be anticipated.

Also, given that the amount of adhesive 50 is small, heat is quickly transferred from the temperature sensing portion cap 100E to the temperature sensing portion 73, enabling use as a fast measurement electronic thermometer to be anticipated. Also, since the accommodating portion does not need to be constituted using any small resin parts in addition to the temperature sensing portion cap 100E, there no increase in production cost.

Referring again to FIG. 16, note that in the case where the electronic thermometer is placed in the subject's armpit, it is better for the temperature sensing portion 73 to be positioned on either the arm side (upper arm side) or the body side of the subject. In view of this, the display surface of the display unit 4 of the electronic thermometer preferably faces in a direction rotated approximately 90 degrees from the temperature sensing portion 73 (A or B direction in the diagram), when the temperature sensing portion cap 100E is seen from the tip side.

Given that the subject places the electronic thermometer in his or her armpit so as to be in a position that allows the display surface of the display unit 4 of the electronic thermometer to be seen, it is possible to ensure that the temperature sensing portion 73 is positioned on either the arm side (upper arm side) or the body side of the subject, irrespective of whether the subject places the electronic thermometer in his or her left armpit or right armpit.

Note that although cases where the outer configuration of the temperature sensing portion cap preferably has a transverse cross-section that is a circular cylindrical shape were described in the above preferred embodiments, the present invention is not limited thereto, and the temperature sensing portion cap can also have a transverse cross-section that is an elliptical cylindrical shape, a rectangular cylindrical shape or the like, for example.

Although preferred embodiments of the present invention have been described above, the preferred embodiments disclosed herein are to be considered in all respects as illustrative and not restrictive. The scope of the present invention is defined by the claims, and all changes that come within the meaning and range of equivalency of the claims are intended to be embraced therein.

1-9. (canceled)

10. A temperature sensing portion cap for use in an electronic thermometer, the electronic thermometer including a hollow main body housing including an opening portion at a tip, a temperature sensing portion that is drawn from inside the main body housing to outside the main body housing through the opening portion by a lead, and the temperature sensing portion cap that accommodates the temperature sensing portion and occludes the opening portion, the temperature sensing portion cap comprising:
a tubular or substantially tubular body portion that is located toward the opening portion of the main body housing; and
a bottomed accommodating portion that is in communication with the body portion and accommodates the temperature sensing portion; wherein
a temperature sensing portion supporting region is provided inside the accommodating portion by an indented region that is indented toward the body portion being located on a tip portion side of an outer surface of the accommodating portion;
the inside of the accommodating portion is divided into two or more temperature sensing portion supporting regions by the indented region; and
the temperature sensing portion is accommodated in one of the temperature sensing portion supporting regions.

11. The temperature sensing portion cap according to claim 10, wherein
the indented region includes a linear recessed groove that is recessed toward the body portion from the tip portion side of the accommodating portion; and
the accommodating portion is divided into two or more temperature sensing portion supporting regions by the recessed groove.

12. The temperature sensing portion cap according to claim 10, wherein
the indented region includes a tubular recessed groove that is recessed toward the body portion from a central tip portion side of the accommodating portion; and
the temperature sensing portion supporting region is annularly defined inside the accommodating portion by the recessed groove.

13. An electronic thermometer comprising:
a hollow main body housing including an opening portion at a tip;
a temperature sensing portion that is drawn from inside the main body housing to outside the main body housing through the opening portion by a lead; and
a temperature sensing portion cap that accommodates the temperature sensing portion and occludes the opening portion; wherein
the temperature sensing portion cap is the temperature sensing portion cap according to claim 10.

14. The electronic thermometer according to claim 13, wherein the main body housing includes a display unit; and
a display surface of the display unit faces in a direction rotated approximately 90 degrees from the temperature sensing portion about a central axis of the temperature sensing portion cap, when the temperature sensing portion cap is seen from a tip side.

15. An electronic thermometer comprising:
a hollow main body housing including an opening portion at a tip;
a temperature sensing portion that is drawn from inside the main body housing to outside the main body housing through the opening portion by a lead; and
a temperature sensing portion cap that accommodates the temperature sensing portion and occludes the opening portion; wherein
the temperature sensing portion cap is the temperature sensing portion cap according to claim 11.

16. The electronic thermometer according to claim 15, wherein
the main body housing includes a display unit; and
a display surface of the display unit faces in a direction rotated approximately 90 degrees from the temperature sensing portion about a central axis of the temperature sensing portion cap, when the temperature sensing portion cap is seen from a tip side.

17. An electronic thermometer comprising:
a hollow main body housing including an opening portion at a tip;
a temperature sensing portion that is drawn from inside the main body housing to outside the main body housing through the opening portion by a lead; and
a temperature sensing portion cap that accommodates the temperature sensing portion and occludes the opening portion; wherein
the temperature sensing portion cap is the temperature sensing portion cap according to claim 12.

18. The electronic thermometer according to claim 17, wherein
the main body housing includes a display unit; and
a display surface of the display unit faces in a direction rotated approximately 90 degrees from the temperature sensing portion about a central axis of the temperature sensing portion cap, when the temperature sensing portion cap is seen from a tip side.
